(19) United States
(12) Patent Application Publication
(10) Pub. No.: US 2002/0178387 A1
(43) Pub. Date: Nov. 28, 2002

(54) System and method for monitoring and managing power use of networked information devices

(76) Inventor: John Theron, Laguna Beach, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/156,270

(22) Filed: May 24, 2002

Related U.S. Application Data
(60) Provisional application No. 60/293,868, filed on May 25, 2001.

(51) Int. Cl. G06F 1/26; G06F 1/28; G06F 1/30

(52) U.S. Cl. 713/300

(57) ABSTRACT

A management and monitoring server monitors and manages power use and power utilization settings of multiple network information devices, such as computers, printers, and network storage devices. An agent, such as a software module, executes on each of the managed information devices to transmit power use data to the server and to receive power setting instructions from the server. A web server provides an interface through which an administrative user can access reports relating to power use by the devices and through which power use settings of the devices can be configured. Reports can include statistical information relating to, for example, hours per day devices spend in various states, such as on, idle, sleep, or monitor standby. Based upon reports and/or specified policies, the server configures power settings of the devices through the agents.

### RELATED APPLICATIONS

This application claims the benefit of U.S. Provisional Application No. 60/293,868, filed on May 25, 2001, which is hereby incorporated by reference.

### BACKGROUND OF THE INVENTION

1. Field of the Invention

This invention pertains to the management of networked distributed information systems, and more particularly to the management and oversight of power consumption by computers and other information devices which are connected via a computer network.

2. Description of the Related Art

Awareness of the importance of the need to conserve electrical power and the substantial amounts of electricity used by computers and other information devices in the office and home setting has increased in recent years. This has led to the creation of software tools that enable information devices to automatically control and limit their use of power. Using these types of software tools, information devices can be configured, for example, to automatically enter power-saving modes after specified periods of inactivity. Such modes are variously called PowerSave, Sleep, or Hibernation modes. Typically, these software tools have taken the form of energy saving software control panels for desktop computers using the Windows and Macintosh operating systems and embedded software for other devices, such as printers, scanners, and copiers..

A system for remotely controlling the on or off setting of a computer is disclosed in U.S. Pat. No. 6,199,180 to Ote et al. In accordance with Ote, a continuously powered, low-power service processor board is configured to control the powering on or off of a managed computer based upon communications received over a computer network from a managing computer. Ote does not, however, teach the monitoring of the power use of computers or the control of power settings other than on or off.

### SUMMARY OF THE INVENTION

A management and monitoring server monitors and manages power use and power utilization settings of multiple network information devices, such as computers, printers, and network storage devices. An agent, such as a software module, executes on each of the managed information devices to transmit power use data to the server and to receive power setting instructions from the server. A web server provides an interface through which an administrative user can access reports relating to power use by the devices and through which power use settings of the devices can be configured. Reports can include statistical information relating to, for example, hours per day devices spend in various states, such as on, idle, sleep, or monitor standby. Based upon reports and/or specified policies, the server configures power settings of the devices through the agents.

In accordance with one embodiment, an information device connected via a network to a server. An agent resides in software on the networked information device. The agent reports information relating to the power utilization status of the networked information device to the server. The server collects this information and stores it. The power utilization of the information device is analyzed based upon the stored information.

In accordance with one embodiment, the server communicates directives to the agent. The agent can use these directives to reconfigure the power utilization characteristics of the information device either directly through interaction with the hardware of the information device or indirectly through operating system or other software.

Although preferably embodied as software programs operating on the networked devices and a server computer, the agent and server may alternatively be embodied as combinations of hardware and embedded software which are connected to the networked information devices and a central server.

One embodiment of the invention is a system for monitoring power utilization of a plurality of networked information devices. The system preferably includes a power monitoring server connected in communication with each of the networked information devices through a computer network. The system also includes, for each of the networked information devices, an associated power monitoring agent operating in conjunction with the networked information device. The power monitoring agent is preferably configured to communicate data relating to utilization of power by the networked information device to the power monitoring server. The power monitoring server is preferably configured to create reports relating to the use of power by the networked information devices based upon the communicated data.

The following aspects can, but need not be included in the aforementioned embodiment. At least one of the power monitoring agents can be configured to adjust power utilization settings of the associated networked information device in response to instructions received from the power monitoring server. The system can also include a database, wherein the power monitoring server is configured to store the communicated data in the database. The system can also include a web server, wherein the reports created by the power monitoring server can be accessed through the web server. At least one of the power monitoring agents can be integrated into an operating system of the associated networked information device. At least one of the power monitoring agents can be an operating system configured to monitor power use. At least one of the power monitoring agents is configured to periodically communicate the power utilization state of the associated networked information device to the power monitoring server at least whenever the associated networked information device is powered on.

One embodiment of the invention is a system for monitoring and managing power utilization of a plurality of networked information devices. The system preferably includes a power monitoring module configured to receive from each of the plurality of networked information devices data relating to power use of the networked information device. The system also includes a power management module configured to control power utilization settings of each of the plurality of networked information devices. The system also includes a web server through which functionality of the power monitoring module and the power management module can be accessed.

The following aspects can, but need not be included in the aforementioned embodiment. The data relating to power use can include a power utilization state of the networked information device. The system can also include a database, wherein the power monitoring module is configured to store the data in the database. The web server can be configured to provide reports relating to the use of power by the plurality of networked information devices based upon data stored in the database. The power management module can be configured to control power utilization settings based on the data received by the power monitoring module. The power management module can be configured to control power utilization settings based on specified policies. In one embodiment, the power utilization settings of each of the plurality of networked information devices can be controlled through the web server.

One embodiment of the invention is a method of monitoring power utilization of a plurality of networked information devices. The method preferably includes receiving from each of the plurality of networked information devices data relating to power use of the networked information device. The method also preferably includes creating reports relating to the use of power by the networked information devices based upon the communicated data. The method also preferably includes providing access to the reports through a web server.

The following aspects can, but need not be included in the aforementioned embodiment. The data can include a power utilization state of the networked information device. The method can include controlling power utilization settings of each of the plurality of networked information devices. The power utilization settings can be controlled through the web server. The power utilization settings can be controlled based upon at least one policy that is specified through the web server.

### BRIEF DESCRIPTION OF THE DRAWINGS

FIG. 1 illustrates a system in accordance with one embodiment for remotely monitoring and managing energy use of networked information devices.

FIG. 2 illustrates a flowchart in accordance with which system administrators can administer organizations, licenses and users.

FIG. 3 illustrates a flowchart in accordance with which organizations can be registered to use the system.

FIG. 4 illustrates a flowchart in accordance with which the system administrator can configure license parameters and administrators for an organization.

FIG. 5 illustrates a menu tree showing options related to organization administration in accordance with one embodiment.

FIG. 6 illustrates an example organization user page.

FIG. 7 illustrates a web page showing an example system logon web page.

FIG. 8 illustrates a menu tree for obtaining summary reports in accordance with one embodiment.

FIG. 9 illustrates a web page showing an example summary report.

FIGS. 10 and 11 illustrate web pages showing example exception reports.

FIG. 12 illustrates a menu tree for accessing detailed reports.

FIG. 13 illustrates a web page showing an example detailed report.

FIG. 14 illustrates a web page showing an “overview” tab of an example user interface.

FIG. 15 illustrates a web page showing a “savings” tab of an example user interface.

FIGS. 16 and 17 illustrate web pages showing “configuration” and “capability” tabs of an example user interface.

### DETAILED DESCRIPTION OF THE INVENTION

In the following description, reference is made to the accompanying drawings, which form a part hereof, and which show, by way of illustration, specific embodiments or processes in which the invention may be practiced. Where possible, the same reference numbers are used throughout the drawings to refer to the same or like components. In some instances, numerous specific details are set forth in order to provide a thorough understanding of the present invention. The present invention, however, may be practiced without the specific details or with certain alternative equivalent devices, components, and methods to those described herein. In other instances, well-known devices, components, and methods have not been described in detail so as not to unnecessarily obscure aspects of the present invention.

### I. OVERVIEW

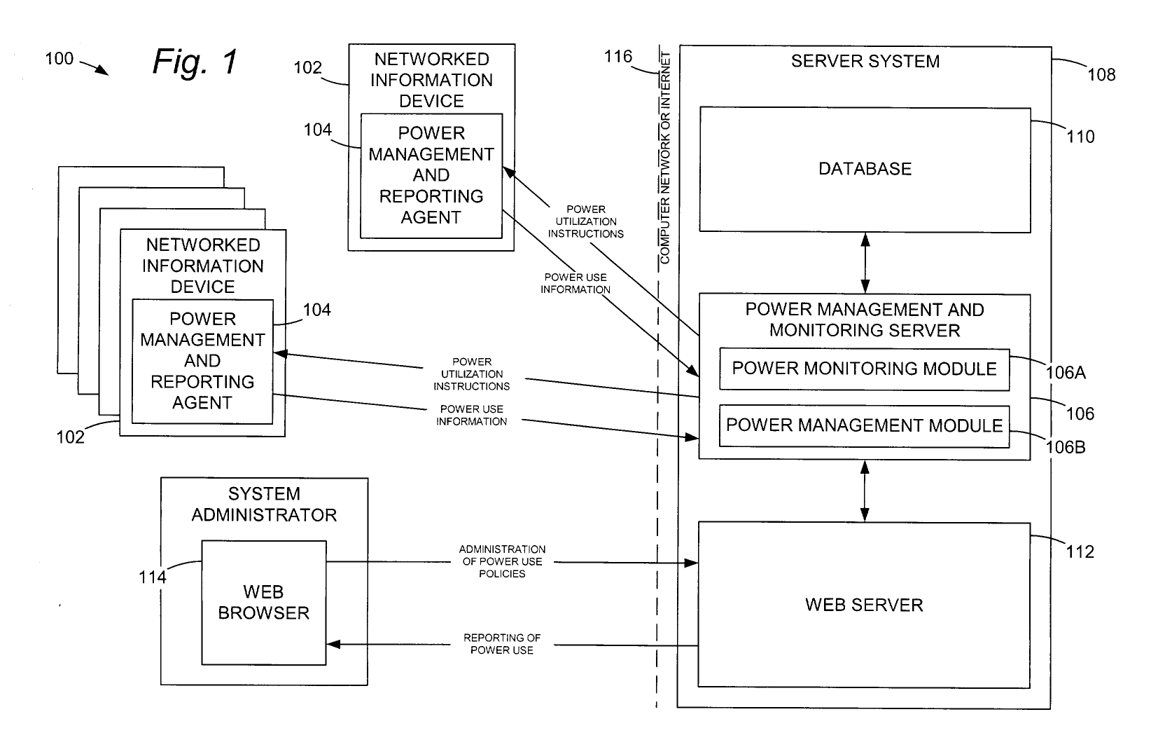

FIG. 1 illustrates a system 100 in accordance with one embodiment of the invention. The system 100 can be configured for remotely monitoring and managing energy use of networked information devices 102, such as computers, servers, disk arrays, printers or other network-connected devices (referred to herein generally as “devices”). The system 100 preferably provides centralized monitoring of device energy usage across an organization, as well as centralized control and configuration of information device power management settings and power states. The system 100 preferably also generates and delivers summary and exception reports that highlight devices wasting energy and recommends and implements energy saving actions.

Power management and reporting agents 104 (also referred to herein as “agents”) are preferably configured to execute or on or operate in conjunction with each managed device. An agent 104 can be a software element operating on the device, a hardware component installed in or on the device, or a combination of software and hardware. In one embodiment, agents run on each information device as a background task, continually monitoring and analyzing power events and sending power use related data to a power management and monitoring server 106. The agents 106 preferably also implement power configuration instructions and commands received from the power management and monitoring server 106.

Information collected and transmitted by the agents 104 can include, for example:

processor on/off times,

monitor on/off times,

hibernation, standby or sleep times,

idle times,

power configuration changes initiated by the device user, and

user login/logout times.

In one embodiment, the agents can be configured to periodically transmit updates regarding the power utilization state of the device and/or transmit updates upon changes to the device's power utilization state. The power utilization state of a device can include, for example:

whether the device is powered on, powered off, on sleep, in hibernation, or on standby,

whether a monitor is powered on, powered off, or on standby,

for how long the device has been idle

the device's power use settings, and

whether a user is logged on to the device.

The power management and monitoring server 106 (also referred to herein as “server”) preferably executes on a server system 108 in conjunction with a database 110 and a web server 112. The server 106 preferably includes a process and associated software executing on the server system 108. The server 106 can be configured to suggest corrective action to improve power utilization efficiency devices 102 or it can be configured to automatically take corrective action. In one embodiment, the server 106 includes a power monitoring module 106A and a power management module 106B, each of which will be described in additional detail below.

The power monitoring module 106A preferably communicates with agents 104 to obtain power use information for each device 102. The monitoring module 106A can be configured to analyze the obtained power use information to create statistical data, summaries and/or reports. The power use information, the statistical data, summaries and/or reports can also be stored in the database 110 for subsequent access and use. The reports and analyses created by the power monitoring module can include, for example:

power usage summaries (e.g. times, locations, patterns, periods, etc.),

device idle time reports,

on/off time reports, and

device configuration reports.

The power management module 106B preferably communicates with agents 104 to configure power utilization settings for devices 102. Agents 104 for computers can be configured to control any of the power utilization setting configurations provided by the computer and/or its operating system. The power utilization settings can include, for example:

idle time before monitor is turned off (or switched to standby),

idle time before hard disks are turned off,

idle time before system sleeps or hibernates, or

an instruction to shut/power down or boot/power up the device.

The power management module 106B can configure devices' power use settings based upon specified policies, current or historical power use data obtained from the devices 102, and/or power availability and pricing data.

In one embodiment, a web server 112 provides a web-based interface through which power use data can be accessed and through which power management policies can be administered. Accordingly, a system administrator or an authorized user can access and configure the power management and monitoring server 106 through a web browser 114 from an Internet or intranet connected computer.

In a preferred embodiment, the devices 102, the server 106, the web server 112, and the web browser 114 are preferably connected in communication through one or more computer networks 116 such as the Internet. Alternatively, the server 106 can be accessed directly through an attached terminal, a wireless connection, or another type of interface.

In certain embodiments, the server 106 can be configured to communicate directly with devices 102, preferably through device operating systems. If a device operating system is capable of configuring the power saving features of the device 102 and supporting communication with the server 106 via some communications method, such as Web Based Enterprise Management (WBEM), then the operating system can serve as the device agent 104.

### II. SYSTEM ADMINISTRATION

In one embodiment, system administrators and/or authorized users can administer the system 100 by using the web browser 114 to connect to the server 106 through the web server 112. Users navigate through system administration pages, entering information which is processed by system administration software and stored in the database 110. Alternatively, the server system 108 can be configured such that the server 106 can be accessed directly through an attached terminal. The server 106 is preferably a secure server requiring a valid logon for access.

In one embodiment, the system 100 is operated by a third party application service provider (ASP) for the benefit of a customer that operates the networked information devices 102. In accordance with this embodiment, the ASP provides power management services for the devices 102 operated by a customer, such as a bank or telecommunications company with many computers. In accordance with one embodiment, the ASP's system administrators can access system administrator functionality and customers can access energy management information.

### A. Organization Registration

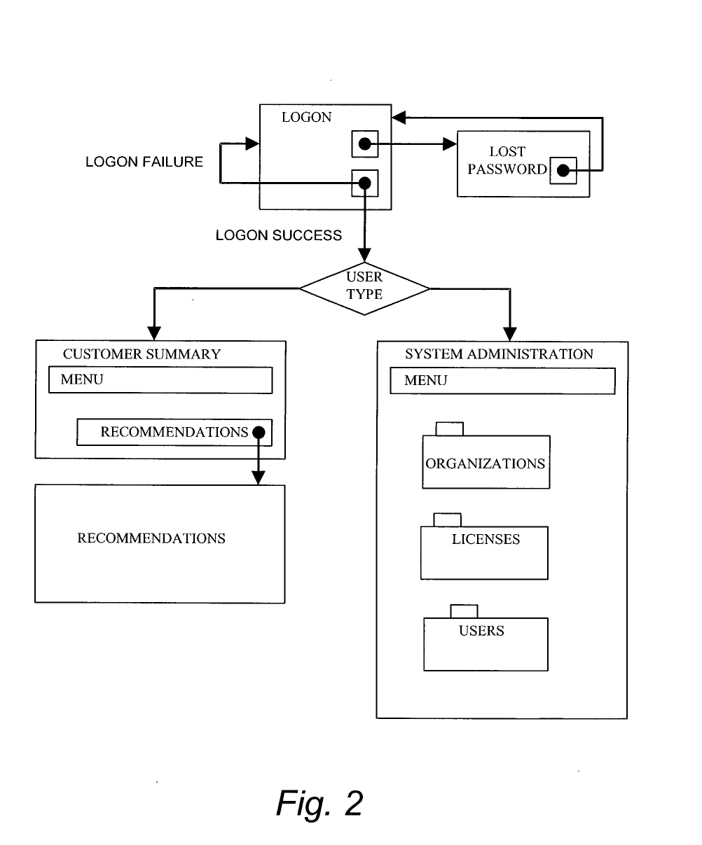

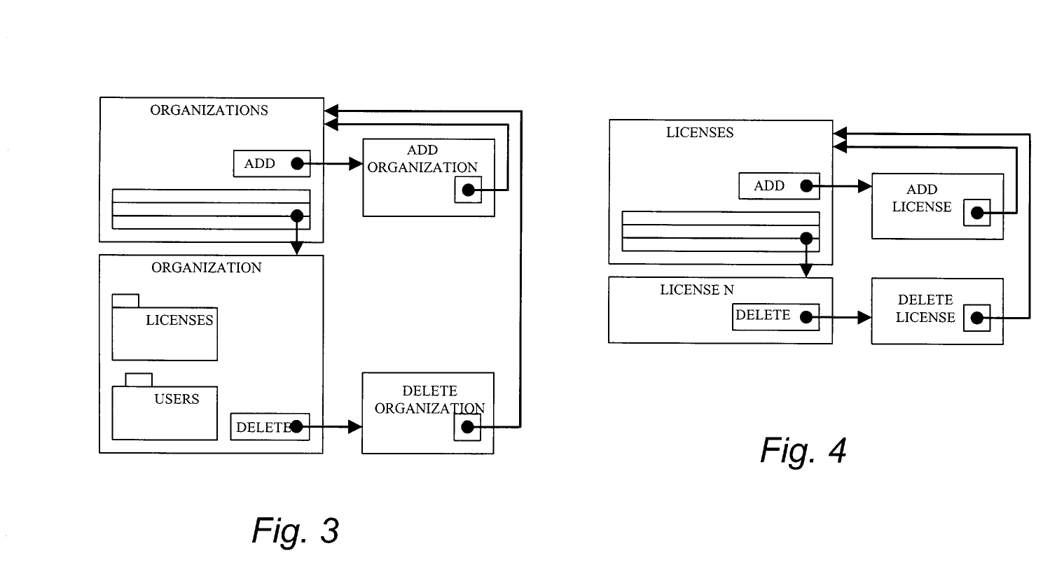

FIG. 2 illustrates a flowchart in accordance with which system administrators can administer organizations, licenses and users. FIG. 3 illustrates a flowchart in accordance with which organizations can be registered to use the system. A secure online registration form is completed by entering organization address and contact details and billing information. The registration software processes the application, stores the organization information in the database 110 and assigns a unique organization ID.

### B. Organization Administration

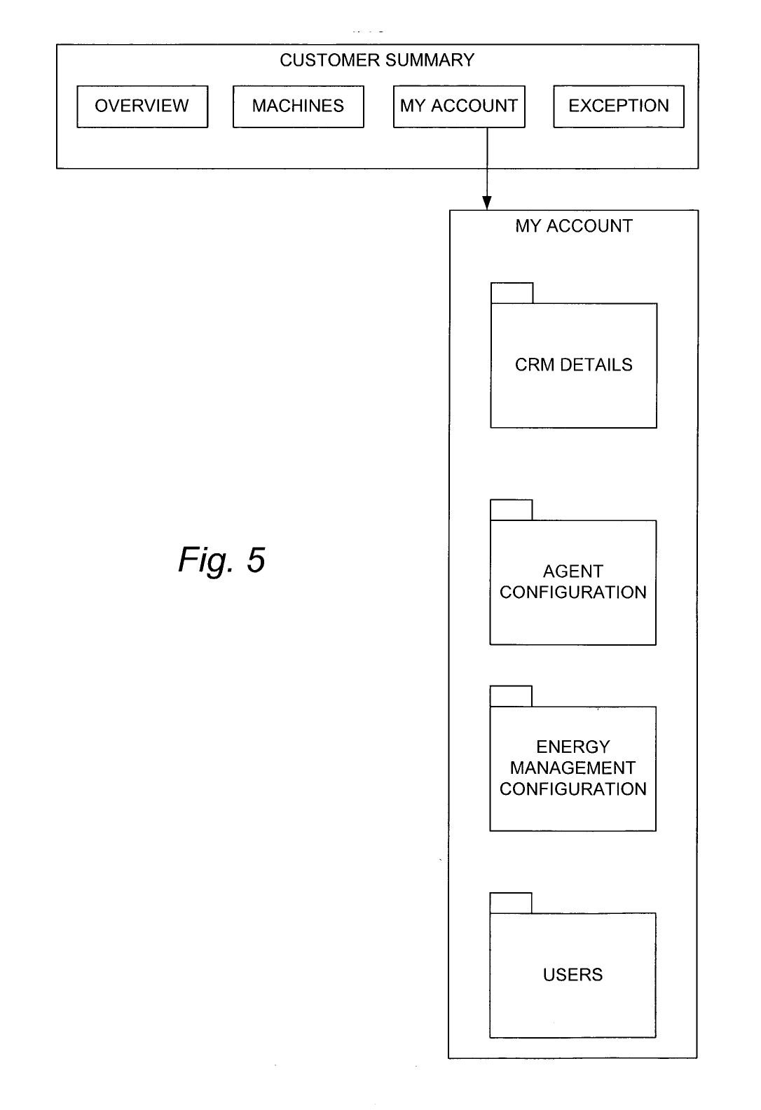

FIG. 4 illustrates a flowchart in accordance with which the system administrator can configure license parameters and administrators for an organization. Once a license and organization administrator have been configured, the organization administrator can configure the organization's energy management system. Organization administration pages enable organization administrators to configure the system and its agents by completing online administration forms with configuration information. The server 106 preferably processes the information and stores the information in the database 110.

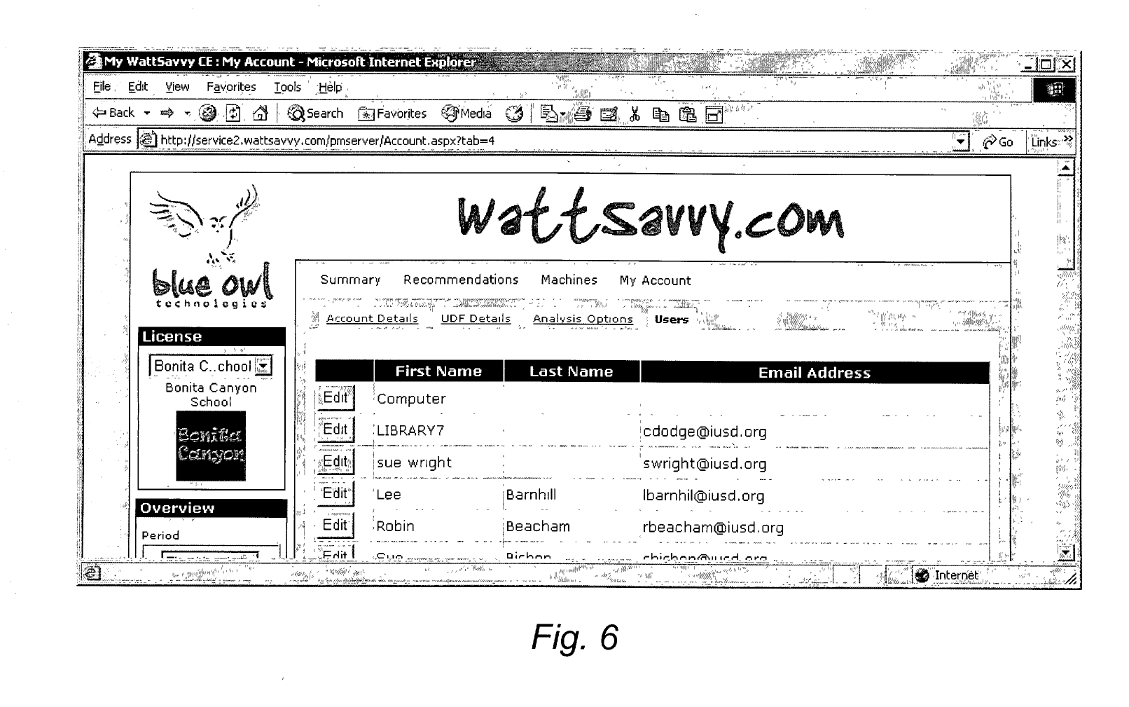

FIG. 5 illustrates options related to organization administration in accordance with one embodiment. Agent configuration information can include:

User interface configuration (Yes/No);

Auto-update configuration (Always/Never/Ask whether to update when a newer agent version is available); and

Security configuration. Transmit sensitive data only using HTTPS, only using HTTP, or using HTTPS when available and otherwise HTTP.

Energy management configuration can include:

Configuration Settings: Overwrite the information device's power management settings, ask whether to overwrite the information device's power management settings, or never overwrite the information device's power management settings;

Power Command control settings: Implement commands, ask whether to implement commands, or never implement commands; and

Values for the default display and device power management settings.

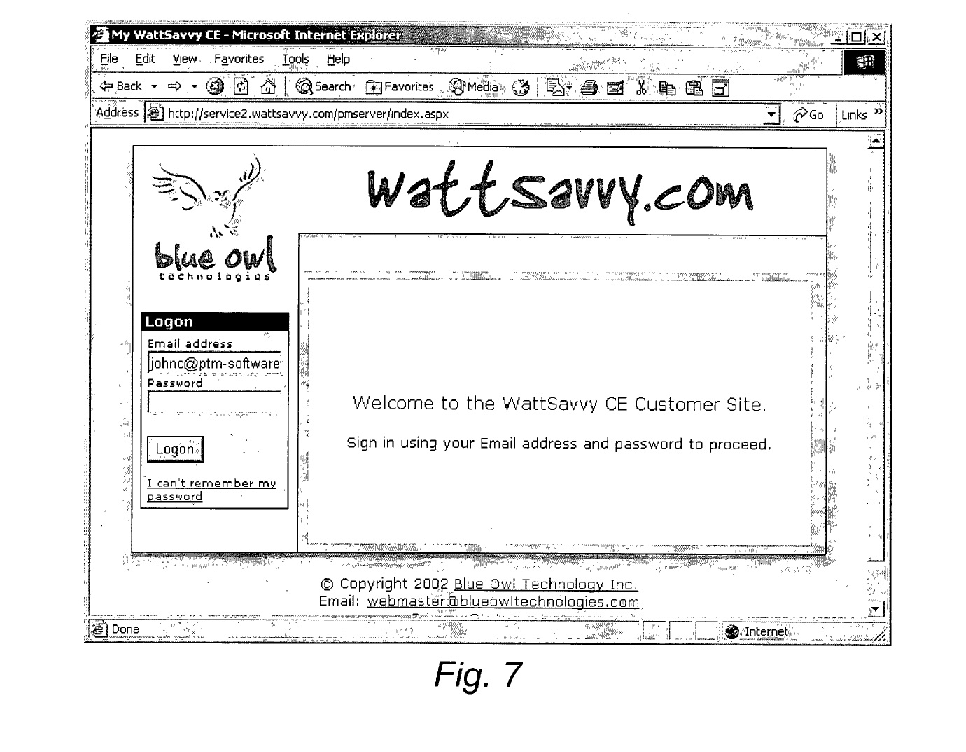

FIG. 6 illustrates an example organization user page. Customer resource management (CRM) information to be collected during agent registration can be defined in the organization administration area. Agent registration information can include a device user e-mail address, device location, device user name, user department, electrical grid circuit number, and other user defined fields to be used for information device identification and power management configuration, control and reporting purposes.

Other administration tasks managed by the administration software can include the management of users (adding, editing and deleting users and managing passwords) and configuring electricity pricing information including time of use pricing information to be used for energy management services.

### C. Agent Deployment and Management

1. Agent Installation

Agents 104 are preferably installed on each information device 102 to be managed by the energy management system 100. The organization administrator can allow users to download agents from the web server 112 for installation on information devices. The organization administrator can also download a CD image to be used for local or network installations or to be pushed across the network from a central location.

2. Agent Registration

The system 100 preferably includes registration software to allow registration of agents online. The agent registration process preferably associates the agent with an organization ID and license, and collects information associated with the information device and/or its user as defined in the organization registration process. Agents can be registered before or after installation.

3. Agent Initialization

In one embodiment, once an install program has completed, it automatically starts the agent. The first time the agent runs, it preferably collects power management capability and configuration data. The agent 104 then connects to the server 106, advising the server that it is a new installation, and sends initial power management data to the server. The server preferably responds by sending a unique machine identifier, sending agent operational parameters, sending power management parameters, and requesting agent registration information, if required.

4. Operational Parameters

The server 106 preferably sends the agent 104 operational parameters when the agent initializes and when the operational parameters are changed by the organization administrator. Data collection parameters can include the frequency of data collection and aggregation, and the amount of data to keep locally in the event the agent cannot connect to the server. Communication parameters can include frequency with which the agent asks the server for a task list, the frequency with which the agent sends aggregate energy usage data, and the URL of the server. Branding parameters can include organization name and logo. License parameters can include licensed functionality, user interface configuration, auto update configuration, grid status configuration, and security configuration.

5. Agent Updates

The agent 104 can be configured to periodically check to see if there is an updated version available for download. Agents can be configured to:

Automatically update to the latest version each time an update is detected;

Ask whether to update each time an update is detected; or

Never check for an update.

### III. ENERGY MANAGEMENT

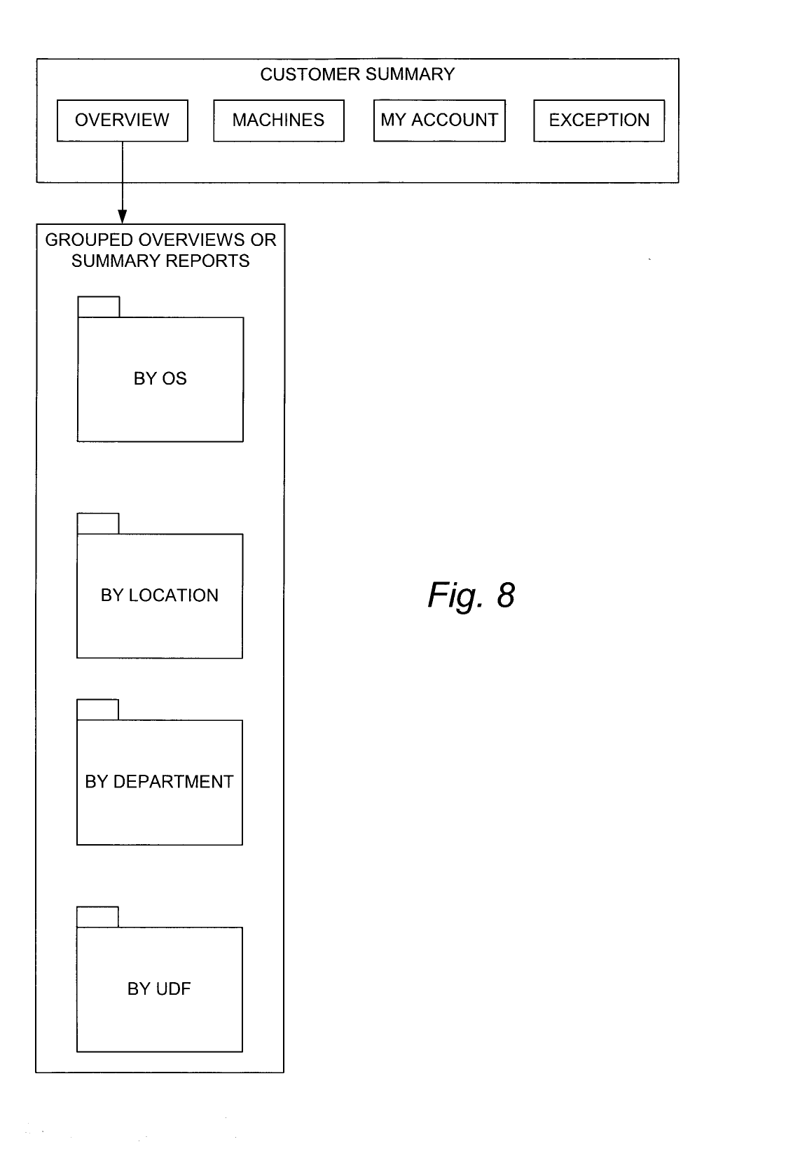

FIG. 7 illustrates an example system logon web page. In one embodiment, authorized users log on to the server 106, preferably through the web server 112, and are directed to their organization's energy management pages.

### A. Power Management Capability Monitoring

In one embodiment, each agent 104 collects data related to a corresponding information device's power management capability each time the capability changes. This data preferably includes operating system data (name, version, build number), hardware information (manufacturer and model number of computer and power consuming components including monitor, processors, disks, RAM and other peripherals), BIOS information including manufacturer, date and version, and power management technology (ACPI or APM).

The agent preferably sends this data to the server 106 upon first run, when the information changes, and when requested by the server 106. The server 106 preferably processes the information and stores it in the database 110.

### B. Power Management Configuration Monitoring

In one embodiment, each agent 104 preferably collects data related to the corresponding information device's power management configuration upon startup, and each time the configuration changes. This data preferably includes power schemes and settings (time to turn off monitor, hard disks, standby and hibernate).

The agent preferably sends this data to the server 106 upon first run, when the information changes, and when requested by the server 106. The server 106 preferably processes the information and stores it in the database 110.

### C. Power Behavior Monitoring

In one embodiment, each agent 104 monitors all power events including power on, power off, standby, hibernate, wakeup, monitor on, monitor off, disks on, disks off, log on, and log off. The agent also preferably monitors CPU, network, disk, keyboard and mouse activity to determine whether the computer is active or idle.

Using these power events and the idle status, the agent calculates the time spent in active, power saving (standby, hibernate, monitor saving, disk saving), power wasting (idle and full power) and off states, and periodically sends this aggregate power behavior information to the server 106. The server 106 preferably processes the information and stores it in the database 110.

### D. Grid Status Monitoring

The agent 104 can be configured to periodically request a grid status from the server 106. The server 106 can be configured to periodically check regional grid status on the Internet.

Preferably the server 106 provides access to reports on current generation status reports, to reports of upcoming localized or rolling power outages, and to external third party power management and consulting services. Additionally, the server preferably provides a knowledge base containing information about the available and optimal power configuration options for various devices 102 on which the agents 104 operate.

In one embodiment, an agent 104 can be configured to control an information device's power state depending on the grid status. For example, a device can be configured to enter a safe power state (device off or hibernate) if a rolling blackout is imminent.

### E. Power Management Configuration

In one embodiment, each agent 104 checks the server 106 for new power management settings periodically. When the agent 104 receives a new power management setting (e.g., set hibernate time to 10 minutes, implement power scheme xyz), the agent configures the device 102 accordingly. The agent preferably sends an indication of the success or failure of the action to the server 106, which processes the information and stores it in the database 110.

### F. Power Management Control

In one embodiment, each agent 104 checks the server 106 for new power state commands periodically. When the agent receives a power command (e.g. turn device off, hibernate device) the agent implements the power command. The agent preferably confirms the success or failure of the action to the server 106, which processes the information and stores it in the database 110.

### G. Summary Reporting

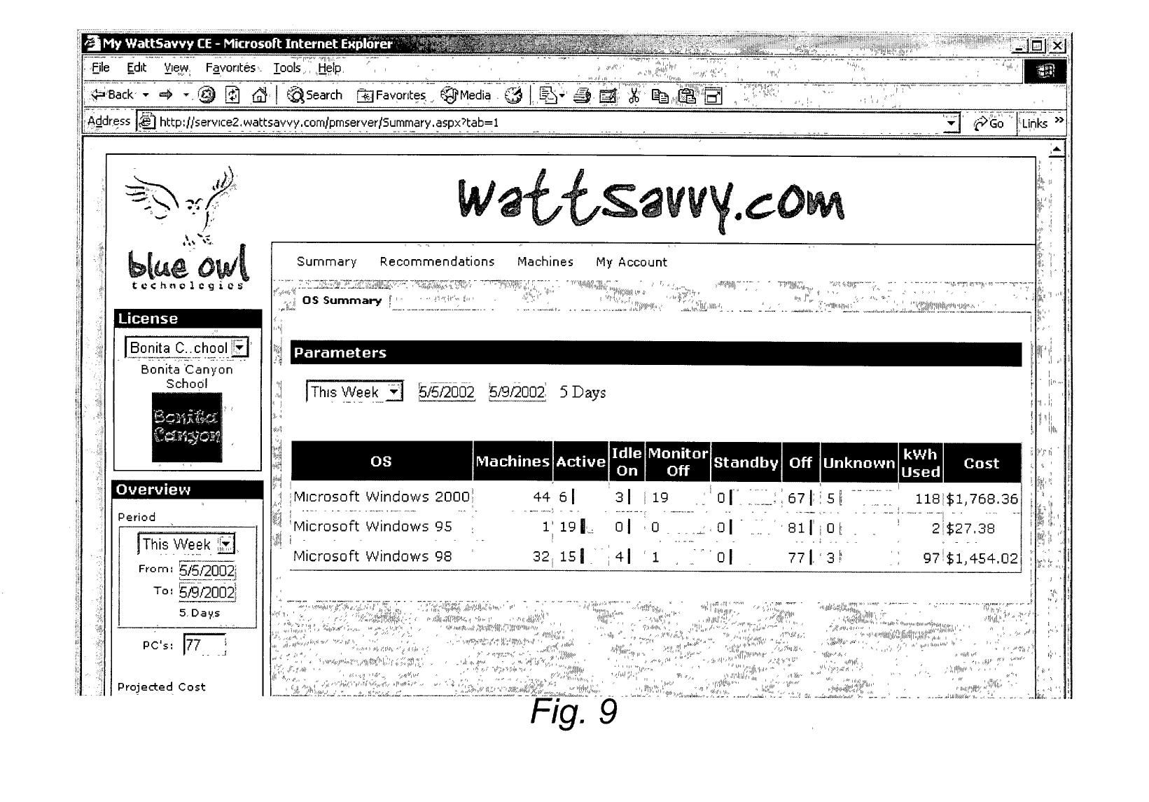

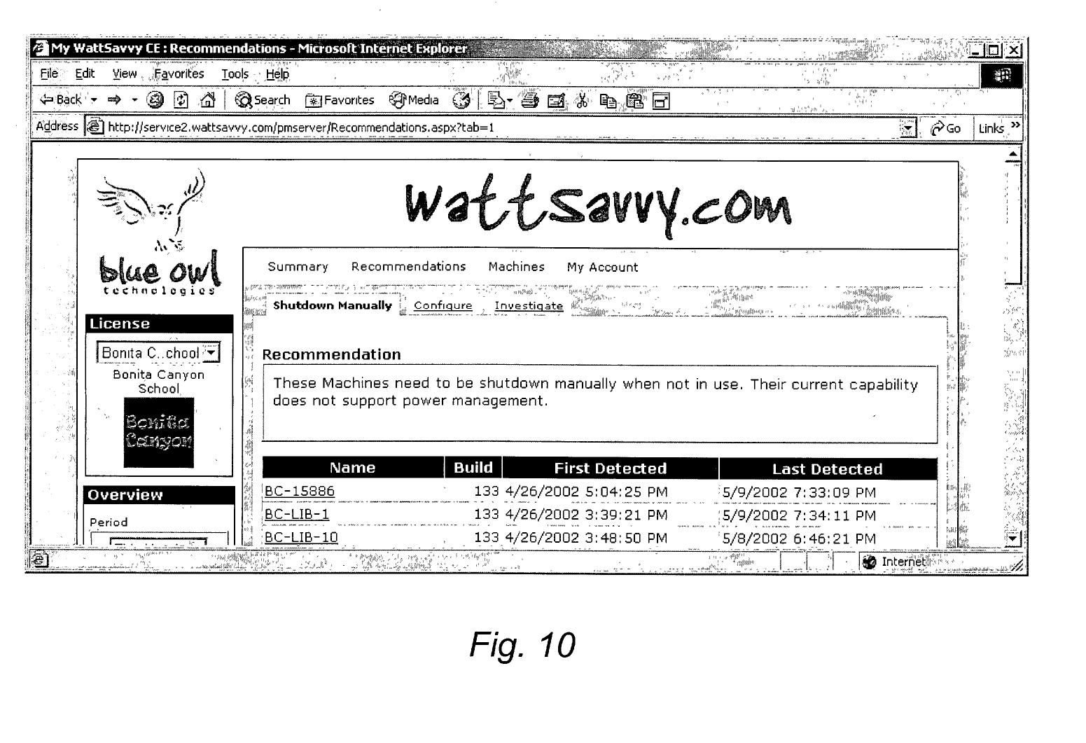

As illustrated in FIG. 8, summary reports present summary information for an organization including aggregate energy usage and energy cost data grouped by location, department, operating system or other user defined criteria. Reports can also be scoped by time. FIG. 9 illustrates a web page showing an example summary report.

### H. Exception Reporting and Remote Configuration and Control

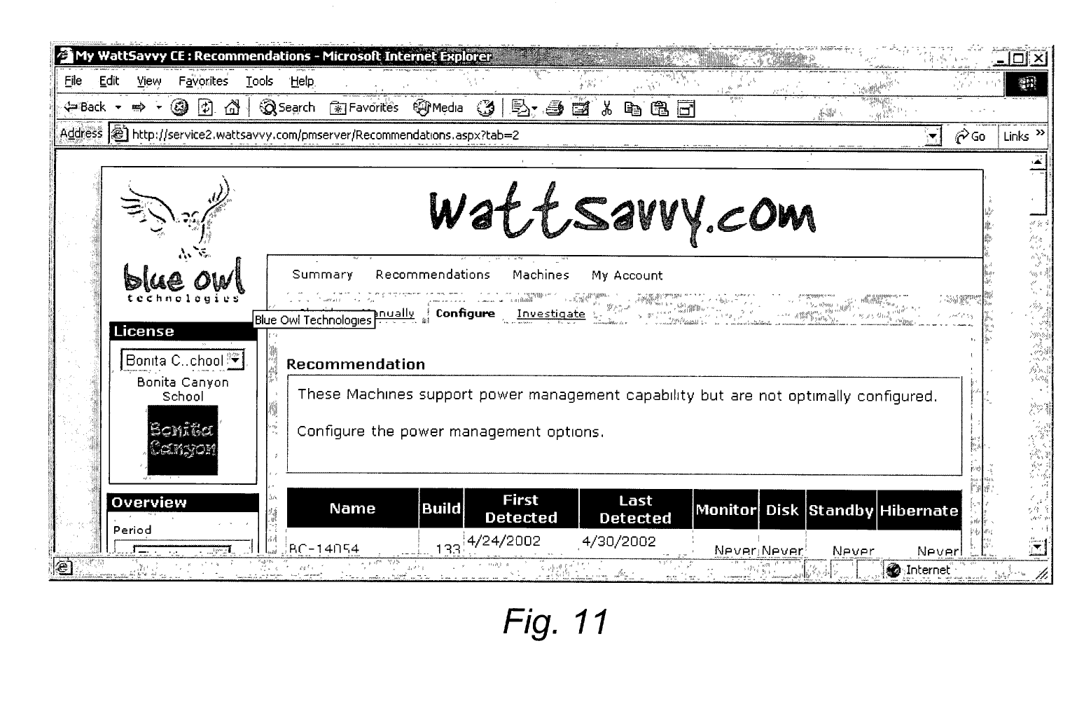

FIGS. 10 and 11 illustrate web pages showing example exception reports. Exception reports identify devices wasting power. These reports can identify: machines that need to be shut down when not in use because they do not support power management, machines that need to be configured for power management, and machines that need to be investigated.

Authorized users can manually adopt recommendations, selectively adopt recommendations and shut down or configure machines from a central location, or configure the system to automatically implement recommendations.

### I. Detailed Reports

Users can also analyze wastage by drilling down to a specific machine to see all data collected by the agent. Users can drill down to a specific time period to see what the machines power state was during that period.

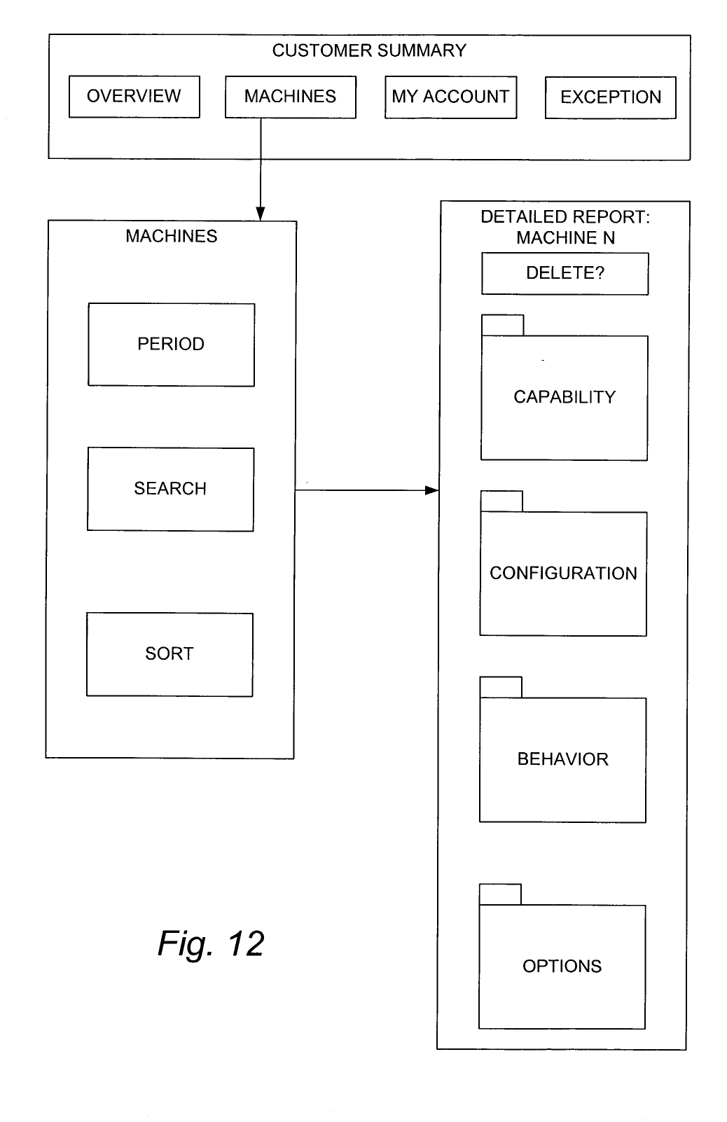

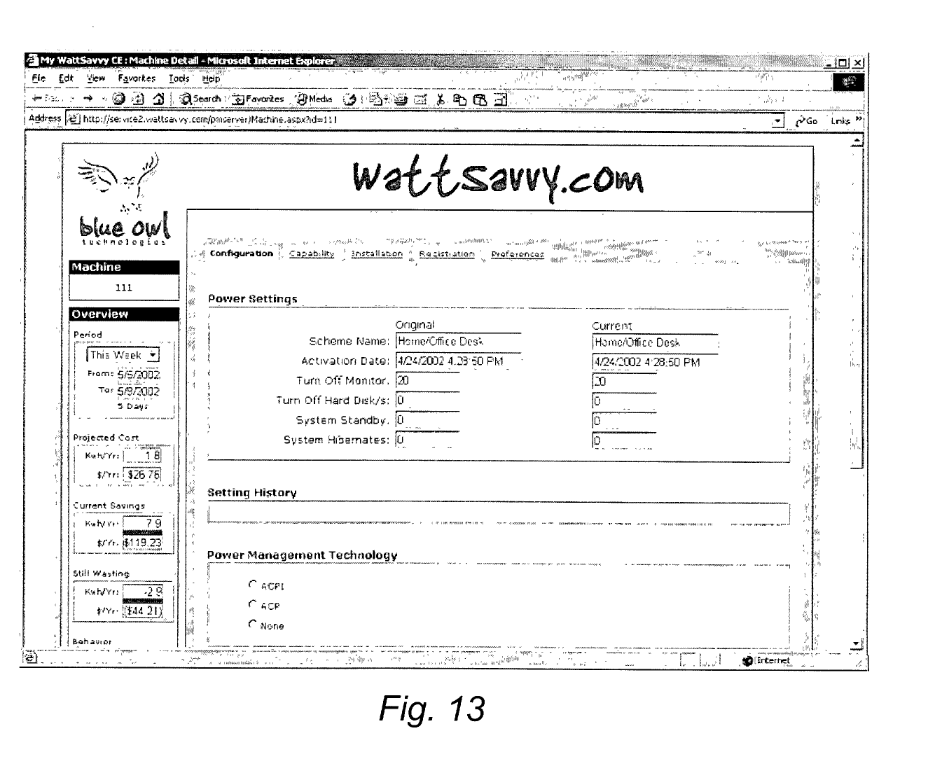

FIG. 12 illustrates a menu tree for accessing detailed reports in accordance with one embodiment. The “period” options can include, for example: today, yesterday, this week, last week, this month, etc. The “search” options can include, for example: department, location, machine name, UDF, OS, addition, attrition, configuration, etc. The “sort” options can include, for example: department, location, machine name, UDF, etc. As shown, a detailed report can be accessed for a particular machine. FIG. 13 illustrates a web page showing an example detailed report.

### J. Agent UI

An agent 104 can run either with or without a user interface. The user interface provides an energy management overview, as well as details of the information device's savings, power configuration and capability, and configuration preferences. The same information can be made available through a browser 113 connected to the web server 112.

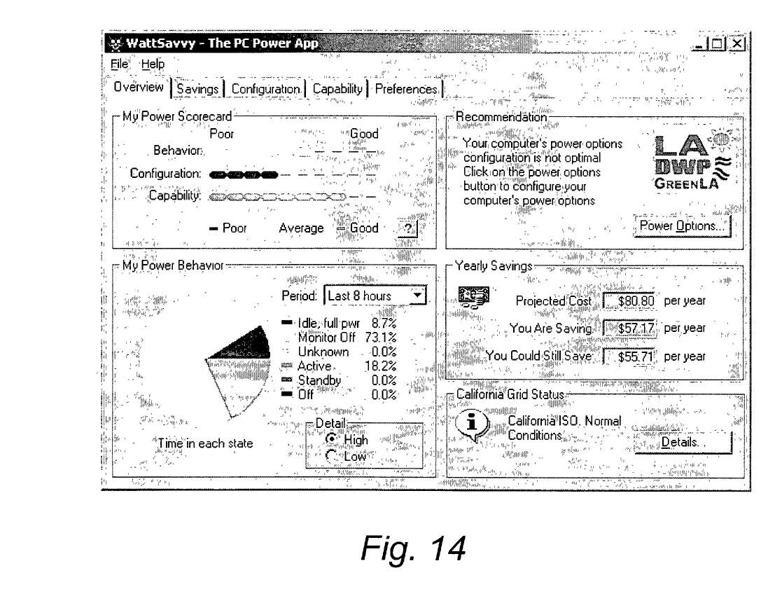

FIG. 14 illustrates a web page showing a “overview” tab of an example user interface. As shown in the example user interface of FIG. 14, the scorecard evaluates the information device's power capability, power configuration and power behavior. The Recommendation section is preferably customized for each computer and is based on the evaluation of the Power Scorecard.

The Power Option button can be configured to start a Control Panel applet, which allows the user to configure the power settings of his computer. The My Power Behavior section can show the history of the user's computer usage in a pie-chart for the time period selected. Users can review this chart to get an indication of the relative amount of time that their computer is conserving power, turned off, wasting electricity, etc. The period drop-down menu can allow the user to change the time period for the calculations shown on this screen. The pie-chart displaying the computer usage and the My Power Scorecard section can be configured to update when the user selects a different time period.

The user interface can also be configured to display the current status of the electrical grid.

### K. Savings

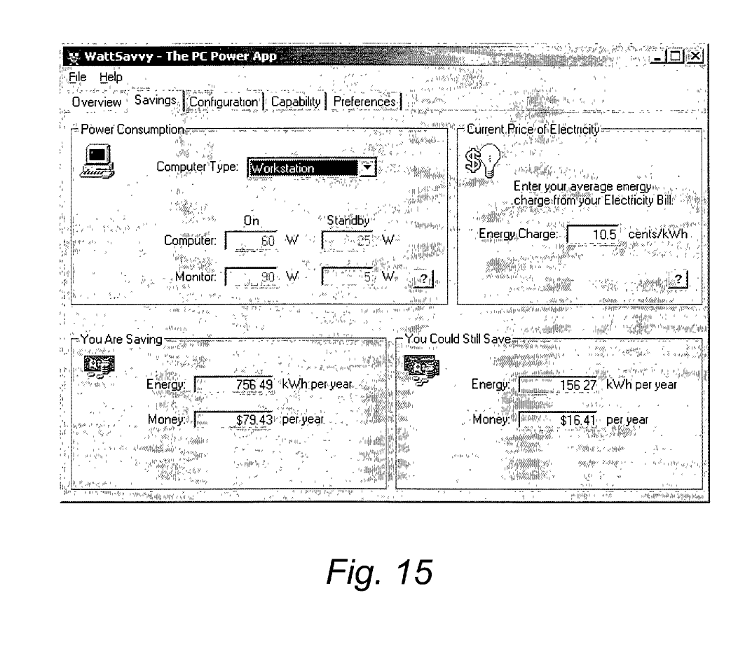

FIG. 15 illustrates a web page showing a “savings” tab of an example user interface. Savings are dependent on the actual power consumed by the user's computer and the actual price paid for electricity. The user interface can be configured to obtain these parameters from the server 106. Users can also configure these values on their own.

The “You are saving” box can show how much money the user will save in a one year period based on the power management behavior of their computer over the selected time period. The “You could still save” box shows how much money could still be saved annually by improving the power management on the user's computer. This value shows how much energy is being wasted by the computer. As users reduce the energy wasted by their computer, the value for further conservation will typically reduce.

### L. Configuration and Capability

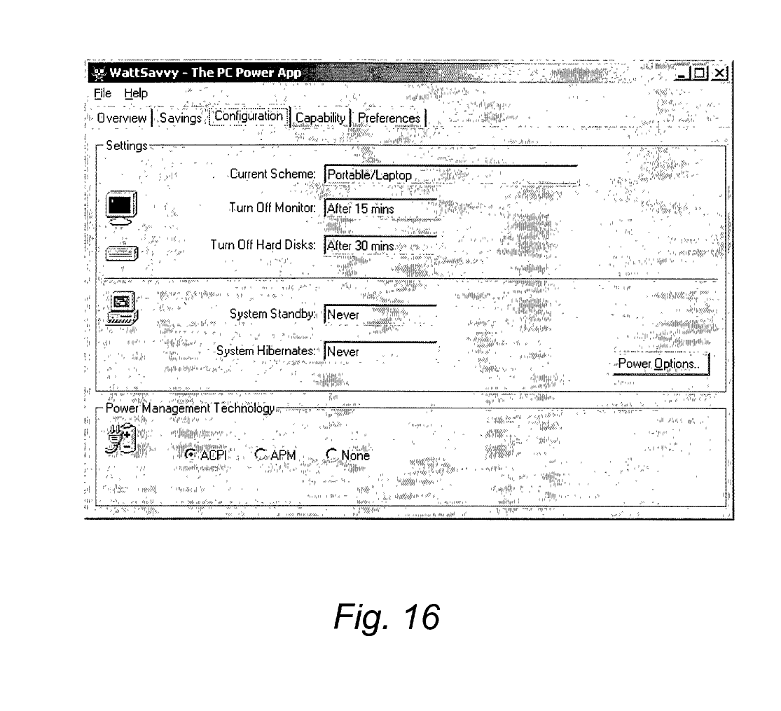

The user interface can also display power management configuration and capability information. FIGS. 16 and 17 illustrate web pages showing “configuration” and “capability” tabs of an example user interface.

### IV. ALTERNATIVE AND ADDITIONAL EMBODIMENTS

The system 100 can also be used to monitor productivity, to monitor user activity, to meter the use of software, and to meter the user of hardware.

In one embodiment, the system 100 can be used to place devices 102 in safe states in the event of a power disturbance.

In one embodiment, summary and/or detailed reports can be e-mailed to administrators or individuals.

In one embodiment, the system 100 can be used by utilities to download stricter power management settings during periods of shortage, rebates associated.

In one embodiment, the system 100 can include a knowledge base concerning bad configurations and sophisticated recommendations

In one embodiment, the system 100 can include separate CRM and operational databases.

In one embodiment, the system 100 can include collector software for devices not connected to the Internet.

### V. CONCLUSION

Although the invention has been described in terms of certain embodiments, other embodiments that will be apparent to those of ordinary skill in the art, including embodiments which do not provide all of the features and advantages set forth herein, are also within the scope of this invention. Accordingly, the scope of the invention is defined by the claims that follow. In the claims, the term “based upon” shall include situations in which a factor is taken into account directly and/or indirectly, and possibly in conjunction with other factors, in producing a result or effect.

What is claimed is:

1. A system for monitoring power utilization of a plurality of networked information devices, the system comprising:
a power monitoring server connected in communication with each of the networked information devices through a computer network; and
for each of the networked information devices, an associated power monitoring agent operating in conjunction with the networked information device, wherein the power monitoring agent is configured to communicate data relating to utilization of power by the networked information device to the power monitoring server, and
wherein the power monitoring server is configured to create reports relating to the use of power by the networked information devices based upon the communicated data.

2. The system of claim 1, wherein at least one of the power monitoring agents is configured to adjust power utilization settings of the associated networked information device in response to instructions received from the power monitoring server.

3. The system of claim 1, further comprising a database, wherein the power monitoring server is configured to store the communicated data in the database.

4. The system of claim 1, further comprising a web server, wherein the reports created by the power monitoring server can be accessed through the web server.

5. The system of claim 1, wherein at least one of the power monitoring agents is integrated into an operating system of the associated networked information device.

6. The system of claim 1, wherein at least one of the power monitoring agents is an operating system configured to monitor power use.

7. The system of claim 1, at least one of the power monitoring agents is configured to periodically communicate the power utilization state of the associated networked information device to the power monitoring server at least whenever the associated networked information device is powered on.

8. A system for monitoring and managing power utilization of a plurality of networked information devices, the system comprising:
a power monitoring module configured to receive from each of the plurality of networked information devices data relating to power use of the networked information device;
a power management module configured to control power utilization settings of each of the plurality of networked information devices; and
a web server through which functionality of the power monitoring module and the power management module can be accessed.

9. The system of claim 8, wherein the data relating to power use comprise a power utilization state of the networked information device.

10. The system of claim 8, further comprising a database, wherein the power monitoring module is configured to store the data in the database.

11. The system of claim 10, wherein the web server is configured to provide reports relating to the use of power by the plurality of networked information devices based upon data stored in the database.

12. The system of claim 8, wherein the power management module is configured to control power utilization settings based on the data received by the power monitoring module.

13. The system of claim 8, wherein the power management module is configured to control power utilization settings based on specified policies.

14. The system of claim 8, wherein the power utilization settings of each of the plurality of networked information devices can be controlled through the web server.

15. A method of monitoring power utilization of a plurality of networked information devices, the method comprising:
receiving from each of the plurality of networked information devices data relating to power use of the networked information device; and
creating reports relating to the use of power by the networked information devices based upon the communicated data; and
providing access to the reports through a web server.

16. The method of claim 15, wherein the data comprise a power utilization state of the networked information device.

17. The method of claim 15, further comprising controlling power utilization settings of each of the plurality of networked information devices.

18. The method of claim 17, wherein the power utilization settings are controlled through the web server.

19. The method of claim 17, wherein the power utilization settings are controlled based upon at least one policy that is specified through the web server.
